(19) United States
(12) Patent Application Publication
(10) Pub. No.: US 2014/0332103 A1
(43) Pub. Date: Nov. 13, 2014

(54) DEVICE FOR REDUCING PRESSURE AND VELOCITY OF FLOWING FLUID

(71) Applicant: SDD CO., LTD, Daejeon (KR)

(72) Inventors: Kab Ju Kwon, Daejeon (KR); Young Bum Kim, Daejeon (KR); Dong Pyo Seo, Daejeon (KR); Jin Hong Kim, Seoul (KR)

(73) Assignee: SDD CO., LTD., Daejeon (KR)

(21) Appl. No.: 14/361,093

(22) PCT Filed: Jun. 27, 2013
(86) PCT No.: PCT/KR2013/005708

§ 371 Date: May 28, 2014

(30) Foreign Application Priority Data
Jun. 27, 2012 (KR) 10-2012-0069095

(51) Int. Cl. F16K 47/08

(52) U.S. Cl. CPC F16K 47/08
USPC 137/625.33

(57) ABSTRACT

The present invention relates to a device for reducing the pressure and velocity of a flowing fluid. According to the present invention, a cage has discs having through holes which come into close contact with an outer surface of a plug. The discs are stacked in a direction of a central shaft of the cage. Flow passage portions are formed on the stacked discs, wherein the flow passage portions communicate with the outer surfaces of the discs, and the inner surfaces which correspond to the through-holes so as to form flow passages between the stacked discs, and the direction of the flow passages changes to a circumferential direction and a vertical direction on the stacked discs. Additionally, the discs are stacked by applying one or more flow passage portions based on the number of times of the direction of the flow passage changes and the number of flow passage portions to the discs so as to control the increasing velocity of the flow rate of the fluid according to the degree of opening formed upon upward movements of the plug.

### TECHNICAL FIELD

The present invention relates to a device for reducing the pressure and velocity of a flowing fluid, and more particularly, to a device for reducing the pressure and velocity of a flowing fluid wherein under the condition where a high differential pressure occurs between inlet and outlet sides of a fluid processing device like a valve, the pressure of the flowing fluid passing through the fluid processing device can be effectively reduced and the flow velocity of the fluid can be restricted to a given level, thus suppressing negative effects occurring from the flowing fluid, such as noise, vibration, cavitation, corrosion, and so on.

### BACKGROUND ART

In the field wherein the precision of the control for the pressure or velocity of a fluid is required under the extreme condition of a high differential pressure, generally, the velocity and pressure of the flowing fluid should be appropriately controlled, and also, a fluid resistor having orifice, labyrinth or tortuous passages is used to obtain long period of life time and good operating state thereof.

The flow velocity occurring in the fluid resistor has a close relation with the total resistance coefficient determined by the difference between the pressures applied to the front and rear ends of the fluid resistor, the shapes of the flow passages, and Reynolds number and with fluid density. That is, an amount of pressure drop in the fluid resistor is proportional to the total resistance coefficient, the fluid density, and the square of the flow velocity, which is indicated by the following equation 1.

$$\begin{matrix}〈 MARGIN 〉 〈 TR 〉 〈 P 〉 〈 CHAR 〉 {ξ}_{1} = f ( geometry ) 〈 / CHAR 〉 〈 / P 〉 & Equation 2 \\ 〈 MARGIN 〉 〈 TR 〉 〈 P 〉 〈 CHAR 〉 {ξ}_{1} ≡ \frac{Δ P}{{ρω}^{2} / 2} = {k}_{Δ} {k}_{Re} {C}_{1} A {ξ}_{loc} 〈 / CHAR 〉 〈 / P 〉 〈 P 〉 〈 / P 〉 & Equation 3\end{matrix}$$

In Equation 1, ΔP indicates an amount of pressure drop of fluid, ξ total resistance coefficient, ρ fluid density, and ω fluid velocity. The amount of pressure drop of fluid is determined according to given applied conditions. If local resistances at each curved portions of the flow passage in the fluid resistor become high, the total resistance coefficient becomes large, and accordingly, the amount of pressure drop of the fluid becomes increased. Through the increment of the amount of pressure drop of the fluid, the velocity and pressure of the fluid can be effectively controlled, and further, the fluid resistor can be more compactedly configured.

In this case, the local resistances at each curved portions of the flow passage are determined upon a geometrical structure such as the curved angle, shape, sectional area, and roughness of each curved portion, the distance between the curved portions, the direction of the flow passage formed by the curved portions, and the like. Accordingly, if the geomtrical structure is effectively adopted, relatively high local resistances and total resistance coefficient can be obtained.

These relations are simply indicated by the following equations 2 and 3.

$$\begin{matrix}〈 MARGIN 〉 〈 TR 〉 〈 P 〉 〈 CHAR 〉 {ξ}_{1} = f ( geometry ) 〈 / CHAR 〉 〈 / P 〉 & Equation 2 \\ 〈 MARGIN 〉 〈 TR 〉 〈 P 〉 〈 CHAR 〉 {ξ}_{1} ≡ \frac{Δ P}{{ρω}^{2} / 2} = {k}_{Δ} {k}_{Re} {C}_{1} A {ξ}_{loc} 〈 / CHAR 〉 〈 / P 〉 〈 P 〉 〈 / P 〉 & Equation 3\end{matrix}$$

In equations 2 and 3, ξ₁ indicates a resistance coefficient of one curved portion, k_{Δ} roughness coefficient of flow passage, K_{Re} coefficient for Reynolds number, C₁ coefficient of cross-sectional shape of flow passage, A coefficient of direction change angle, and ξ_{loc} resistance coefficient of given shaped curved portion.

A variety of fluid resistors have been developed under the above-mentioned theoretical basis, and these are proposed in U.S. Pat. Nos. 5,941,281, 5,819,803, 4,921,014, 4,617,963, 4,567,915, 4,407,327, 4,352,373, 4,279,274, and 4,105,048.

Conventional fluid resistors include a plurality of discs or cylinders stacked on top of each other. The pressure or flow rate of the fluid resistor can be controlled by distributing the energy of the fluid through the direction changes of the flow passages formed separatedly on the discs or cylinders or through the variation of the sectional areas of the flow passages. So as to avoid the generation of noise and cavitation, further, given labyrinth or curved shapes are suggested so as to increase the flow resistance of each flow passage, while multipath and multistage are being combined with each other.

As apparent from the above equations, if the roughness of the flow passage, the pressure difference between the front and rear ends of the device, the cross-sectional area of the flow passage, and the given shape of the flow passage are appropriately adjusted, the pressure of the fluid and the flow velocity of the fluid can be controlled to a desired level.

That is, the flow resistance can be effectively obtained through the correlation between the above-mentioned variables. Among the above-mentioned variables, the formation of curved flow passages is widely used as the geometrical structure of the flow passage having the most influence on the flow resistance. Through the curved flow passages, the fluid is changed in the flowing direction thereof, so that the flowing fluid forms vortexes to cause the loss of energy thereof, thus producing flow passage resistances.

Further, the geometrical structure of the flow passage whose cross-sectional area is drastically expanded and reduced allows the flowing fluid to form vortexes to cause the loss of energy thereof, thus producing flow passage resistances. This structure provides a relatively higher flow passage resistance (by about 2 times) than the curved flow passage structure.

If the curved flow passage structure and the flow passage structure wherein the cross-sectional area is drastically expanded and reduced are adopted together, accordingly, a compact fluid pressure reducing device, which is capable of controlling the pressure of the fluid and the flow velocity of the fluid to a desired level, can be made. Further, the fluid pressure reducing device should be made, while suppressing the occurrence of noise. That is, a main source of noise is aerodynamic noise, and noise energy has a relation with mass flow rate, pressure ratio of downstream side absolute pressure to upstream side absolute pressure, geometrical structure, and physical features of the fluid. If the pressure ratio is high at a given portion, acoustic velocity flow or choked flow by flashing occurs to cause high noise and vibration, and accordingly, the pressure ratio is controlled to restrict or suppress the occurrence rate of noise. So as to reduce the pressure ratio, therefore, the given portion, that is, the flow passage is formed with the geometrical structure as mentioned above wherein the flow rate can be decreased.

If the flow rate of the fluid becomes fast in fluid processing equipment, corrosion, abrasion, and noise are increased. For example, if the flow rate of water flowing in the equipment made of carbon steel is more than 30-40 ft/sec, corrosion occurs. If the flow velocity of the fluid becomes fast at a specific portion (for example, a local portion of an orifice or valve), the generation of noise is accelerated. As the flow velocity of the fluid is increased, the pressure of the fluid is lowered, and at this time, if the pressure is decreased to a vapor pressure or less, the fluid is vaporized to cause flashing. Further, if the pressure is recovered to the vapor pressure or more at the rear end of the fluid processing device, cavitation occurs. In the fluid processing equipment, noise, vibration, corrosion and abrasion may be serverely generated, and therefore, the fluid resistor applied to specific conditions should not have any drastic pressure and velocity variations.

So as to remove the negative effects occurring in the fluid processing device, it is recommenced by Guy Borden (Control Valves: Practical Guides for Measurement and Control, Instrument Society of America, 1998) that the kinetic energy at the outlet side of a fluid should be lowered and limited in accordance with the degree of damages or noise reference values. According to IEC (International Electrotechnical Commission) Standard (IEC-534-8-3-1995, ‘Industrial-Process Control Valves, Part 8: Noise Considerations, Section 3: Control Valve Aerodynamic Noise Prediction Method’), further, methods for reducing noise include a method for decreasing the flow rate of the fluid (acoustic efficiency approaching method) and a method for increasing noise frequency (frequency change approaching method). That is, if the mass flow of the fluid and the kinetic energy of the fluid with respect to velocity are lowered, acoustic efficiency, acoustic power, and sound pressure level are decreased. Further, if the hole through which the fluid is passed is divided into a plurality of parts, peak frequency of noise is moved to high parts. Accordingly, the peak frequency of noise is over the range of audible noise frequency of a human being, and the transmission loss of noise is increased, thus decreasing the noise.

So as to restrict the flow rate of fluid occurring by high pressure difference between the front end and the rear end of the fluid processing device, flow resistors having zigzag flow passages have been suggested in the conventional practices. That is, conventional flow control devices for reducing the pressure of a fluid and adjusting the flow velocity of the fluid are disclosed in U.S. Pat. No. 6,615,874 (issued on Sep. 9, 2003) and U.S. Pat. No. 7,766,045 (issued on Aug. 3, 2010).

FIGS. 1 to 3 show the flow control device disclosed in U.S. Pat. No. 6,615,874, which is provided in the form of a valve trim assembly. As shown, a plurality of flow passages 4 is formed along fluid passages formed between a fluid inlet 2 and a fluid outlet 3. Each flow passage 4 is formed on a valve trim disc 1 to form an expansion and contraction mechanism 5, a velocity control mechanism 6, an acoustic chamber 7, and frequency change passages 8. The expansion and contraction mechanism 5 has the cross-sectional area wherein the flow passage is drastically expanded and contracted. The velocity control mechanism 6 forms a relatively small cross-sectional area in the fluid inlet 2 and a relatively large cross-sectional area in the fluid outlet 3. The acoustic chamber 7 is formed to remove the sound generated from the expansion and contraction mechanism 5 and the velocity control mechanism 6. The frequency change passages 8 are formed toward the fluid outlet 3 from the acoustic chamber 7 so as to increase the audible frequency of the fluid with respect to the acoustic disturbance related to the fluid flow passages.

Under the above-mentioned structure, the zigzag flow passages changed in direction to the left and right sides by a given angle ⊖ are formed on the fluid resistor, and through the expansion and contraction of the fluid, the flow resistance of the fluid can be formed.

According to the flow control device disclosed in U.S. Pat. No. 6,615,874, however, a relatively low flow resistance occurs from one zigzag flow passage, and therefore, the zigzag flow passages should be plurally formed so as to obtain a desired flow resistance value, which makes the size of the device undesirably increased.

Further, FIG. 4 shows a fluid pressure reducing device having two or more stackable discs 10, which is disclosed in U.S. Pat. No. 7,766,045. The discs 10 have cavity center portions 11 and peripheral portions 12 formed in the vertical shafts thereof when they are stacked on top of each other. Each disc 10 includes one or more inlet flow passage sections each having an inlet flow passage end 13 having a first inlet area 14 and a first outlet area 15 and one or more outlet flow passage sections each having an outlet flow passage end 16 having a second inlet area 17 and a second outlet area 18. In this case, the ratio of the second inlet area to the second outlet area is in advance determined to form a back pressure at the outlet flow passage end, thus allowing subsonic fluid flow to be formed to the vicinity thereof.

In the similar manner to the above-mentioned conventional practice as disclosed in U.S. Pat. No. 6,615,874, by the way, the fluid pressure reducing device as disclosed in U.S. Pat. No. 7,766,045 has the zigzag flow passages changed in the upward and downward directions of the stacked discs, so that the expansion and contraction of the fluid can be formed through the flow passages stacked on the flow passages divided in the flowing direction of the fluid.

Accordingly, the fluid pressure reducing device as disclosed in U.S. Pat. No. 7,766,045 just forms a relatively smaller fluid flow resistance when compared with the available volume thereof. So as to obtain a desired flow resistance, therefore, the number of zigzag flow passages should be increased, which undesirably causes the size of the device and the space occupied by the device to be bulky.

Another fluid resistor has been disclosed in Korean Patent No. 0438047 (entitled ‘device for reducing velocity and pressure of fluid’) issued to the same applicant as the invention.

According to the conventional disc column type fluid resistor as disclosed in Korean Patent No. 0438047, as shown in FIG. 5, a plurality of discs is stacked on top of each other, and each disc includes a plurality of circular coupling holes formed in a circumferential direction along the outer peripheral surface thereof, a first through hole pattern 25 formed with a plurality of T-shaped through holes 24 periodically formed between the rectangular groove portion having a fluid inlet 22 formed along the inner peripheral surface of the disc and the the rectangular groove portion having a fluid outlet 23 formed along the outer peripheral surface of the disc, a second through hole pattern 26 formed with a plurality of T-shaped through holes 24 periodically formed radially at a given angle in the circumferential direction of the first through hole pattern 25, third and fourth through hole patterns 28 and 29 formed with a plurality of square holes 27 periodically formed radially at a given angle in the circumferential directions of both sides of the first and second through hole patterns 25 and 26, so that the first to fourth patterns 25 to 29 are periodically formed with angular symmetry in the circumferential direction of the disc. Accordingly, the discs having the same patterns are stacked and coupled to form a disc column, and thus, four discs stacked and coupled to each other are rotated by a given angle so as to allow the four patterns to be arranged sequentially in an axial direction of the disc column, thus forming the three-dimensional flow passages in the circumferential and radial directions thereof. Further, four discs are periodically stacked and coupled to the coupled four discs to form the disc column, thus forming the three-dimensional flow passages in the axial direction of the disc column.

Further, vortex forming spaces 30 are formed at the positions before the three-dimensional flow passages are changed in direction perpendicularly. In this case, the vortex forming spaces 30 are formed by the square hole patterns in the axial direction of the disc column and by the T-shaped flow passage holes in the circumferential and radial directions thereof.

According to the conventional disc column type fluid resistor as disclosed in Korean Patent No. 0438047, at this time, the vortex forming spaces 30 are protrudedly formed by the T-shaped flow passage holes in the radial direction of the disc. So as to obtain the separated distance between the T-shaped flow passage holes in the radial direction of the disc, accordingly, the number of T-shaped flow passage holes should be decreased, and otherwise, the radial size of the disc should be increased.

If the number of T-shaped flow passage holes is decreased, the number of direction changing times of the curved flow passages is reduced and accordingly it is difficult to reduce the flow velocity and pressure of the fluid to a desired level.

If the radial size of the disc is increased, on the other hand, the radial size of the device is increased, and accordingly, the overall size of the device becomes large.

### DISCLOSURE

### Technical Problem

Accordingly, the present invention has been made in view of the above-mentioned problems occurring in the prior art, and it is an object of the present invention to provide a device for reducing the pressure and velocity of a flowing fluid wherein under the condition where a high differential pressure occurs between inlet and outlet sides of a fluid processing device like a valve, the pressure of the flowing fluid passing through the fluid processing device can be effectively reduced and the flowing velocity of the fluid can be restricted to a desired level.

It is another object of the present invention to provide a device for reducing the pressure and velocity of a flowing fluid that can be compactedly configured in the available volume of a fluid processing device like a valve.

It is yet another object of the present invention to provide a device for reducing the pressure and velocity of a flowing fluid that can control the increasing flow rate of the fluid according to a degree of opening to a desired level.

It is still another object of the present invention to provide a device for reducing the pressure and velocity of a flowing fluid wherein flow passages can be simply formed and the loss of energy of the fluid can be increased, without having any separate space for forming vortexes.

### Technical Solution

To accomplish the above-mentioned objects, according to the present invention, there is provided a device for reducing the pressure and velocity of a flowing fluid, which is disposed in a fluid processing device having a body having an inlet and an outlet, a plug moved between the inlet and the outlet so as to adjust the flow rate of the fluid, a seat ring adapted to block the flow of the fluid in such a manner as to be brought into contact with the plug, and a cage contacted with the outer peripheral surface of the plug so as to allow the fluid to be passed therethrough in accordance with the upward and downward movements of the plug, wherein the cage has a plurality of discs each having a through hole with which the outer peripheral surface of the plug is brought into close contact, and the discs are stacked on top of each other in the center shaft direction of the cage, the stacked discs being adapted to form flow passage portions so as to form flow passages therebetween, the flow passage portions communicating with the outer peripheral surfaces of the discs and the inner peripheral surfaces of the discs corresponding to the through holes of the discs and being changed in direction in circumferential directions and vertical directions of the stacked discs, the discs being stacked by applying one or more flow passage portion patterns based on the number of direction changing times of the flow passages and the number of flow passage portions to the discs so as to control the increasing velocity of the flow rate of the fluid according to the degree of opening upon upward movements of the plug.

According to the present invention, preferably, the flow passage portion patterns are formed on two or more discs in the same shape as each other.

According to the present invention, preferably, one flow passage portion pattern has the number of direction changing times corresponding to the multiples of 3.

According to the present invention, preferably, each flow passage portion includes a plurality of flow passage units each having an entry portion and a passage portion connectedly extended from the entry portion at a right or acute angle with respect to the entry portion, the passage portion of one flow passage unit being connected to the entry portion of the flow passage unit of another disc stacked on the disc.

According to the present invention, preferably, each flow passage portion includes a plurality of flow passage units each having an entry portion and a passage portion connectedly extended from the entry portion at a right or acute angle with respect to the entry portion and connection units adapted to connect the flow passage units with each other in a vertical direction, and the passage portion of one flow passage unit is connected to the entry portion of the flow passage unit of another disc stacked on the disc through the connection units stacked on top thereof.

According to the present invention, preferably, the width of the passage portion is larger than the width of the entry portion.

According to the present invention, preferably, the passage portion has a vortex forming portion formed on the end thereof so as to form vortexes before the fluid enters the entry portion of the flow passage unit formed on another disc from the end of the passage portion in the state where the entry portion of the flow passage unit formed on another disc connected to the end of the passage portion is spaced apart from the end and side surfaces of the passage portion on the plane thereof.

According to the present invention, preferably, the entry portion and the passage portion are provided in the form of grooves depressed to a given depth.

According to the present invention, preferably, the entry portion and the passage portion are penetratedly formed into each disc.

According to the present invention, preferably, partitions are stacked on the top and underside of the discs forming one flow passage portion pattern.

According to the present invention, preferably, the passage portion is curvedly formed.

### Advantageous Effects

According to the present invention, the device for reducing the pressure and velocity of a flowing fluid is configured wherein under the condition where a high differential pressure occurs between inlet and outlet sides of a fluid processing device like a valve, the pressure of the flowing fluid passing through the fluid processing device can be effectively reduced and the flowing velocity of the fluid can be restricted to an appropriate level, thus suppressing negative effects such as noise, vibration, cavitation, corrosion, and so on.

That is, the curved flow passages and the vortex forming spaces are repeatedly formed in the shape of the grooves or holes penetratedly formed on the discs of the cage, and accordingly, the flow of the fluid at a rapid velocity forms turbulent flows from which irregular vortexes are produced in the flow passages, so that the pressure of the fluid and the flow velocity of the fluid are decreased through the loss of energy caused by the flow resistance of the fluid, that is, velocity head loss, thus preventing the above-mentioned negative effects occurring from high flow velocity.

According to the conventional three-dimensional flow passage structure (U.S. Pat. No. 5,819,803), only the cross-sectional area of the flow passage is drastically expanded and drastically contracted to form a perpendicularly curved flow passage. In this case, a pair of discs having different shapes from each other is provided wherein one disc forms a radial flow of fluid and the other induces the radial flow of fluid, thus forming the curved flow passage. According to the present invention, contrarily, the device for reducing the pressure and velocity of a flowing fluid removes the problems such as noise, vibration, corrosion and abrasion caused by the local velocity increment and the drastic variations of the pressure of the fluid. According to the thermodynamic and fluid dynamic features of the fluid, that is, the device of the present invention forms the vortex forming spaces just before the flow passages are changed to the vertical direction so as to greatly increase the resistance coefficients every the direction changing portion to the vertical direction in the flow passages.

According to the present invention, if the vortex forming spaces exist just before the directions of the flow passages are changed, the resistance coefficient of of the curved portion is more increased by about 1.2 times than that having no vortex forming spaces, as indicated by the following equation 4.

$$〈 MARGIN 〉 〈 TR 〉 〈 P 〉 {ξ}_{s} ≡ \frac{Δ P}{{ρω}^{2} / 2} \approx 1.2 {ξ}_{1} 〈 / P 〉 〈 P 〉 〈 / P 〉 \qquad Equation 4$$

In this case, the fluid forms the vortexes in the vortex forming spaces to cause the loss of rotational energy therefrom, and accordingly, the kinetic energy of the fluid passed through the vortex forming spaces is lost by the rotational energy used for the vortex formation. If drastic pressure variations occur due to external factors (for example, in the state of the drastic acceleration of the fluid), the vortex forming spaces serve as the impact-absorbing spaces where the impact of fluid can be absorbed before the fluid is curved perpendicularly, thus effectively reducing the kinetic energy of the fluid.

According to the present invention, further, the conventional problem wherein the formation of the plurality of zigzag flow passages makes the size of the device bulky is solved to allow the fluid processing device to be made to a compact size.

According to the present invention, additionally, a variety of flow passage portion patterns are suggested to allow the increment in the flow rate of the fluid according to the degree of opening to be controlled to a desired level, thus adjusting the flow rate of the fluid in accordance with the environments used or features of the valve.

According to the present invention, furthermore, the flow passages can be simply formed and the loss of energy of the fluid can be increased, without having any separate space for forming vortexes, thus easily manufacturing the device and increasing the lengths of the flow passages, irrespective of the sizes of the discs.

### DESCRIPTION OF DRAWINGS

FIGS. 1 to 5 show conventional devices for reducing the pressure of a flowing fluid.

FIG. 6 is a longitudinal sectional view showing a valve on which a device for reducing the pressure and velocity of a flowing fluid according to the present invention is mounted.

FIG. 7 is a perspective view showing the basic configuration of the device for reducing the pressure and velocity of a flowing fluid according to the present invention.

FIGS. 8 to 10 show the basic configuration of the device for reducing the pressure and velocity of a flowing fluid according to the present invention.

FIGS. 11 and 12 show the arrangements of flow passage units under the basic configuration of the device for reducing the pressure and velocity of a flowing fluid according to the present invention.

FIGS. 13 and 14 show the arrangements of flow passage units and connection units under the modified configuration of the device for reducing the pressure and velocity of a flowing fluid according to the present invention.

FIGS. 15 and 16 are graphs showing flow rate variations according to a degree of opening.

FIGS. 17a to 17c show the unit pattern of the flow passage portion.

FIGS. 18 to 23 show various patterns of the flow passage portions according to the present invention.

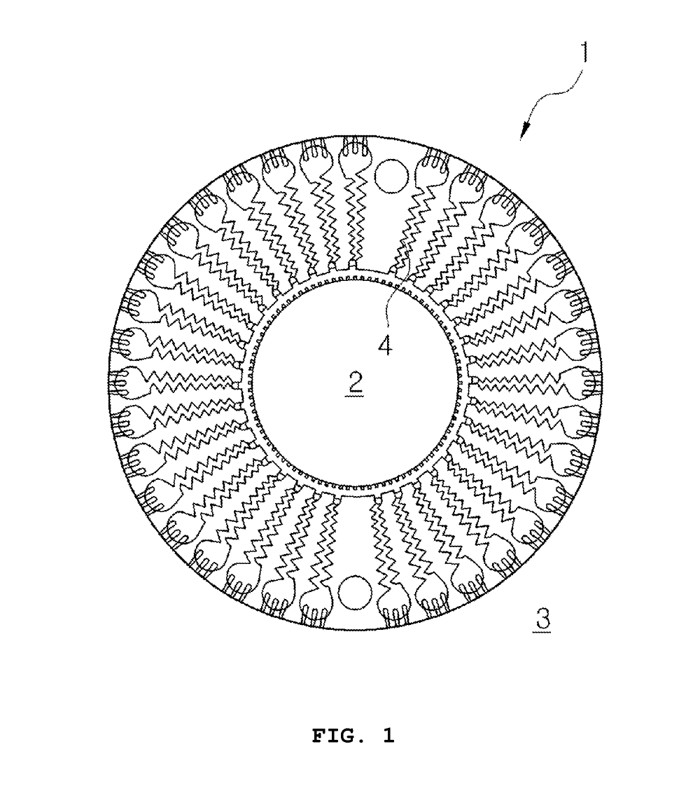

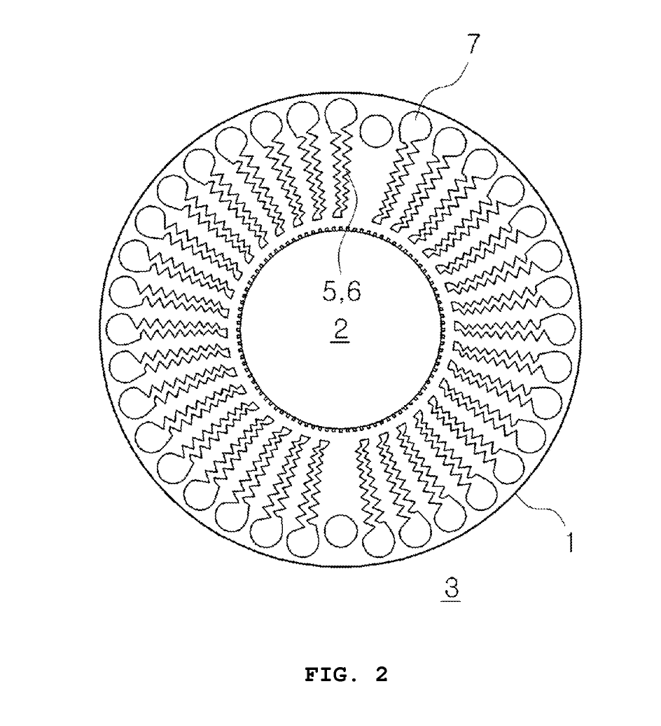

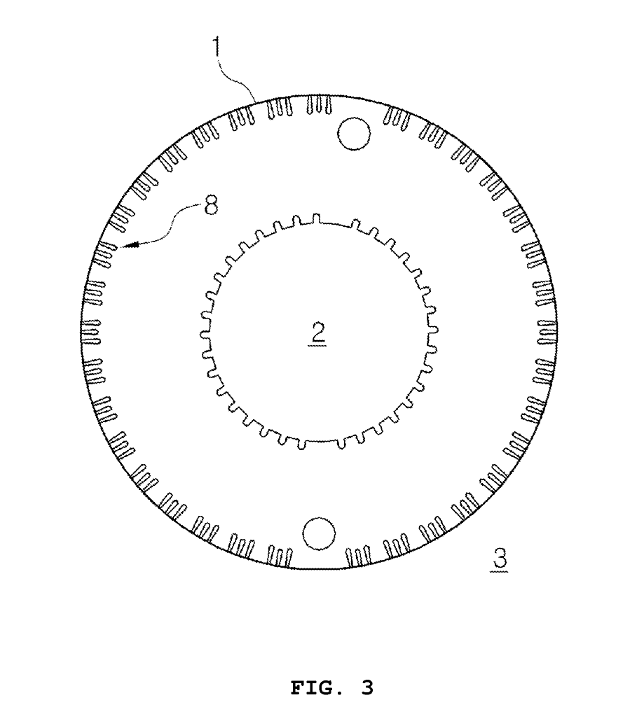

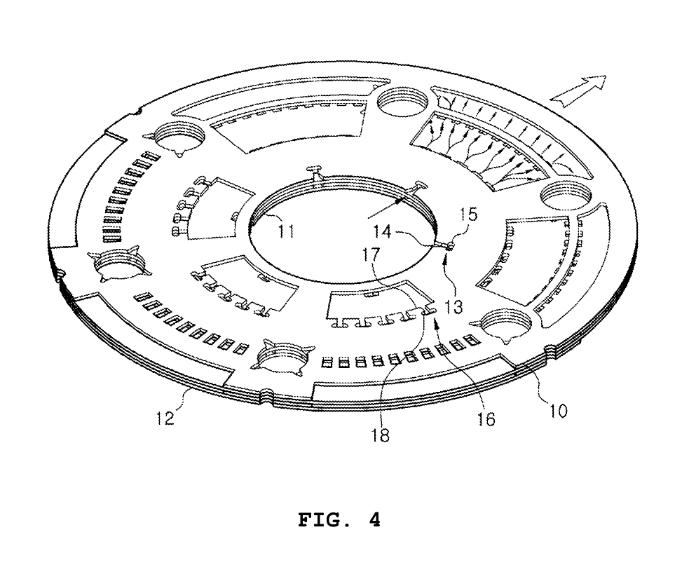

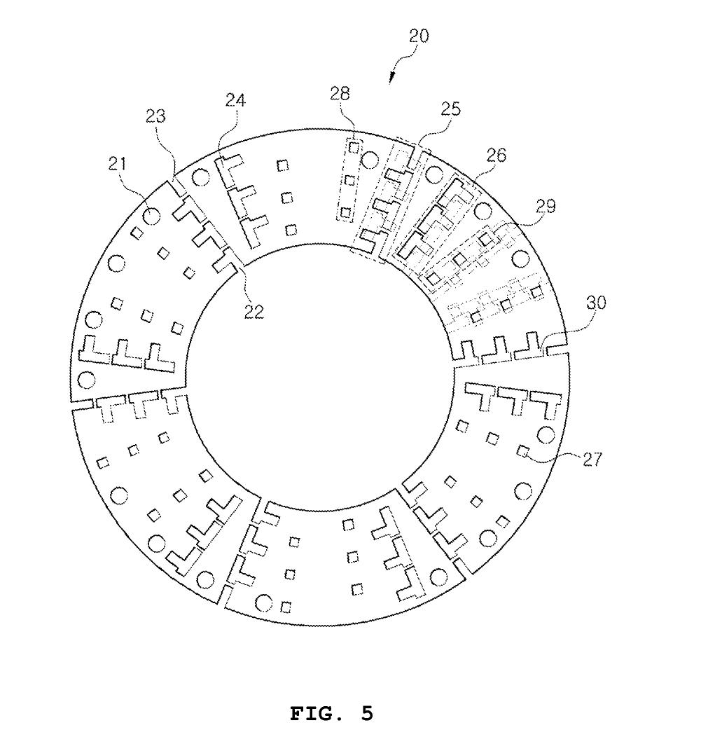

### BEST MODE FOR INVENTION

Hereinafter, an explanation on a device for reducing the pressure and velocity of a flowing fluid according to the present invention will be in detail given with reference to the attached drawings. In the description, a valve is provided as a fluid processing device, but in addition to the valve, the present invention may be applied to all kinds of devices having a high differential pressure between inlet and outlet sides.

Basic Configuration

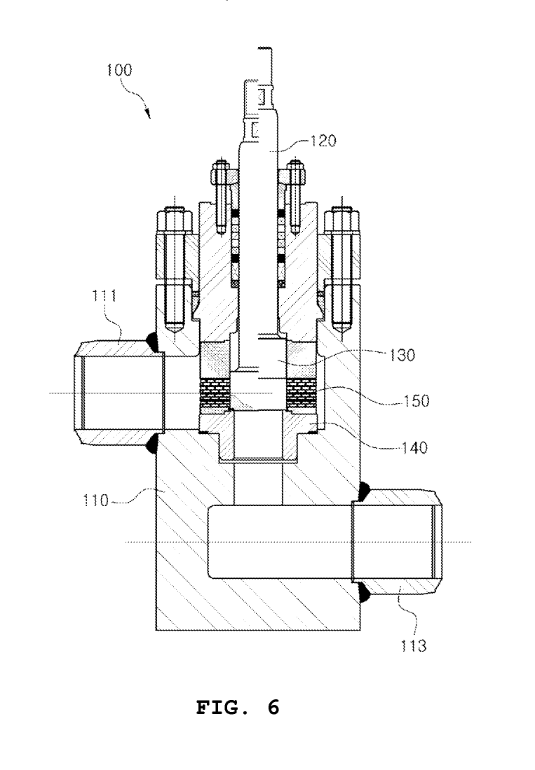

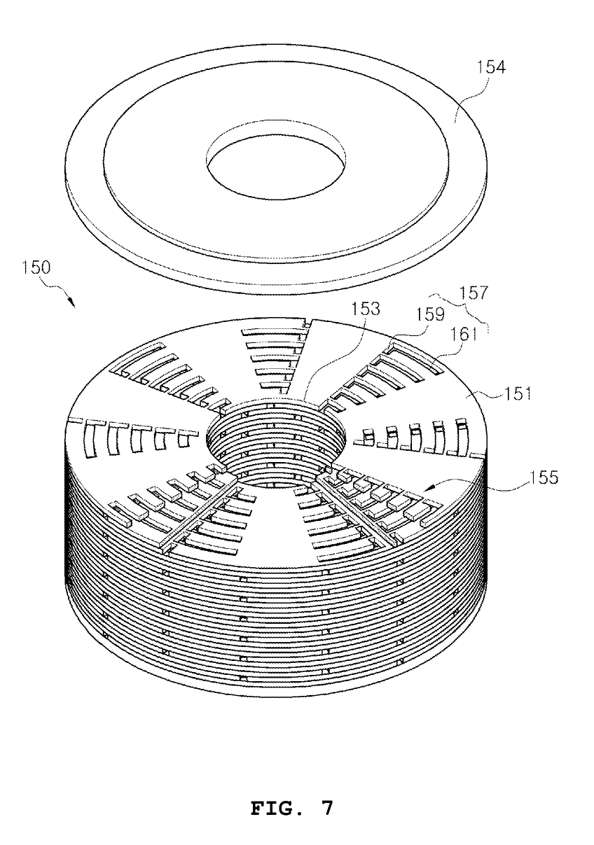

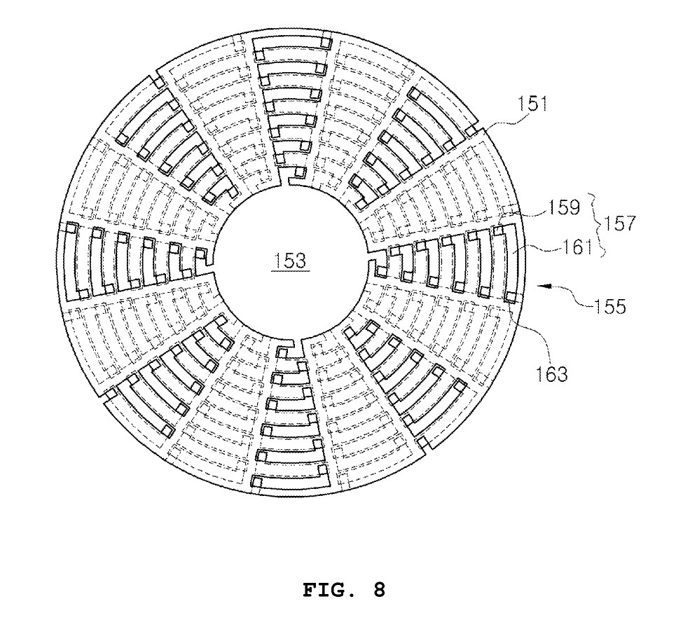

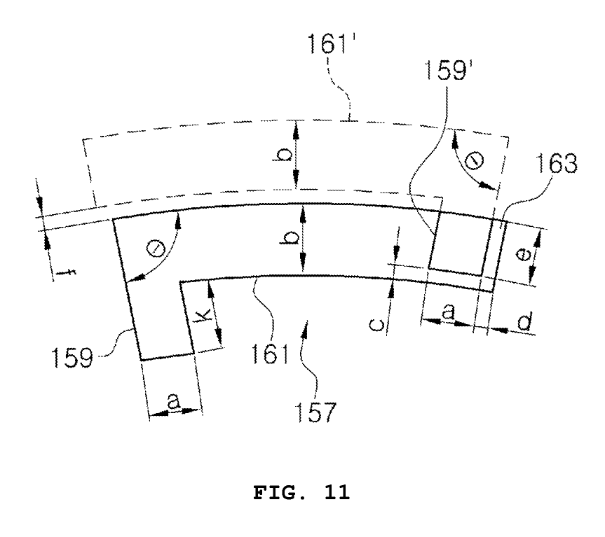

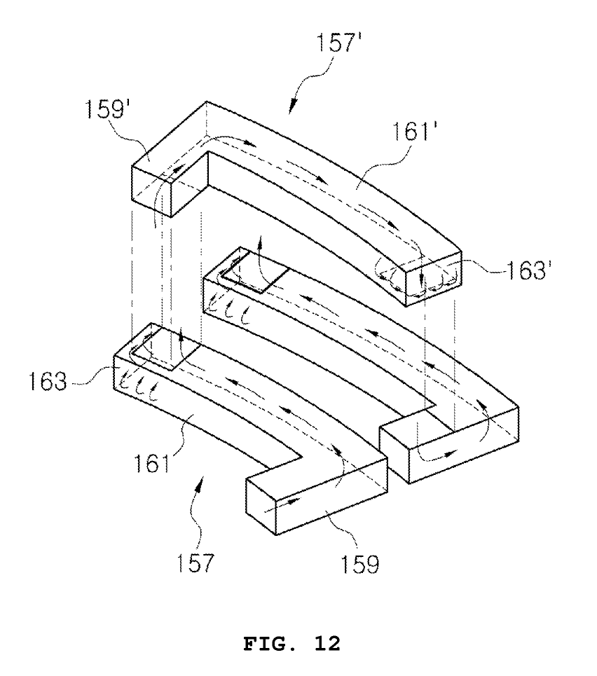

FIG. 6 is a longitudinal sectional view showing a valve on which a device for reducing the pressure and velocity of a flowing fluid according to the present invention is mounted, FIG. 7 is a perspective view showing the basic configuration of the device for reducing the pressure and velocity of a flowing fluid according to the present invention, FIGS. 8 to 10 show the basic configuration of the device for reducing the pressure and velocity of a flowing fluid according to the present invention, and FIGS. 11 and 12 show the arrangements of flow passage units under the basic configuration of the device for reducing the pressure and velocity of a flowing fluid according to the present invention.

As shown in FIGS. 6 and 7, a device for reducing the pressure and velocity of a flowing fluid according to the present invention is mounted in a cage 150 within a valve 100 as a kind of a fluid processing device. On the other hand, the directions of an inlet 111 and an outlet 113 of the valve 100 may be changed in accordance with the characteristics of the valve 100 and the kind of a fluid used. Further, a flow rate of the fluid in the valve 100 is adjusted in accordance with the upward and downward movements of a plug 130 connected to a stem 120. That is, if the plug 130 is moved upward as shown in the right side part with respect to the center line in FIG. 6, a flow passage is open to increase the flow rate of the fluid, and contrarily, if the plug 130 is moved downward as shown in the left side part with respect to the center line in FIG. 6, the flow passage is closed to decrease the flow rate of the fluid.

According to the present invention, the valve 100 includes a body 110 having the inlet 111 and the outlet 113, the plug 130 moved between the inlet 111 and the outlet 113 so as to adjust the flow rate of the fluid, a seat ring 140 adapted to block the flow of the fluid in such a manner as to be brought into contact with the plug 130, and the cage 150 contacted with the outer peripheral surface of the plug 130 so as to allow the fluid to be passed therethrough in accordance with the upward and downward movements of the plug 130.

The cage 150 has a plurality of discs 151 each having a through hole 153 with which the outer peripheral surface of the plug 130 is brought into close contact, and the discs 151 are stacked on top of each other in the center shaft direction of the cage 150. The number of discs 151 stacked is appropriately determined in accordance with the flow rate used of the valve 100 and the moving distance of the plug 130.

Further, cover plates 154 are disposed on top and underside of the stacked discs 151.

So as to constitute the cage 150 through the plurality of discs 151, furthermore, the discs 151 are coupled to each other by means of welding, pins, bolts or brazing.

The cage 150 serves to pass the fluid therethrough in accordance with the upward and downward movements of the plug 130, and accordingly, flow passages are formed radially outwardly from the through holes 153 of the discs 151. According to the present invention, two or more neighboring discs 151 are cooperatively operated with each other to form the flow passages.

In more detail, each disc 151 has a plurality of flow passage units 157 each having an entry portion 159 and a passage portion 161, and the flow passage units 157 are cooperatively operated with a plurality of flow passage units 157′ of another disc 151′ adjacent to the disc 151 to allow the directions of the flow passages to be changed in the circumferential and vertical directions of the discs, thus forming flow passage portions 155 passing through the outer peripheral surfaces of the discs 151 and 151′ and the inner peripheral surfaces corresponding to the through holes 153.

The flow passage units 157 are formed in the same patterns as each other on one disc 151, and the flow passage units 157′ connecting the neighboring flow passage units 157 to each other are formed on the disc 151′ stacked on the disc 151.

If the entry portions 159 of the flow passage units 157 are located around the outermost or innermost peripheral surface of the disc 151, they are open toward the inner or outer peripheral surface of the disc 151, but contrarily, if they are located on the inner side of the disc 151, they are connected to the flow passage units stacked vertically on each other, so that they are closed on their sides.

Further, the passage portions 161 are connectedly extended from the entry portions 159 at a right or acute angle with respect to the entry portions 159. As a result, the flow passage portions 155 can be appropriately shaped and arranged on the available spaces of the discs 151.

Further, if the passage portions 161 are located around the outermost or innermost peripheral surface of the disc 151, they are open toward the inner or outer peripheral surface of the disc 151, but contrarily, if they are located on the inner side of the disc 151, they are connected to the flow passage units stacked vertically on each other, so that they are closed on their sides.

Also, the entry portions 159 and the passage portions 161 may be provided in the form of grooves depressed to a given depth, and otherwise, as shown, they are penetratedly formed into the discs 151. If the entry portions 159 and the passage portions 161 are penetratedly formed into the discs 151, the portions where the flow passage units 157′ are not formed on the neighboring disc 151′ are brought into contact with the portions where the flow passage units 157 are formed on the disc 151, so that the top and underside ends of the entry portions 159 and the passage portions 161 are blocked. Otherwise, a flat plate type partition (not shown) on which the flow passage units are not formed is stacked on top of the disc 151, thus blocking the top and underside ends of the entry portions 159 and the passage portions 161.

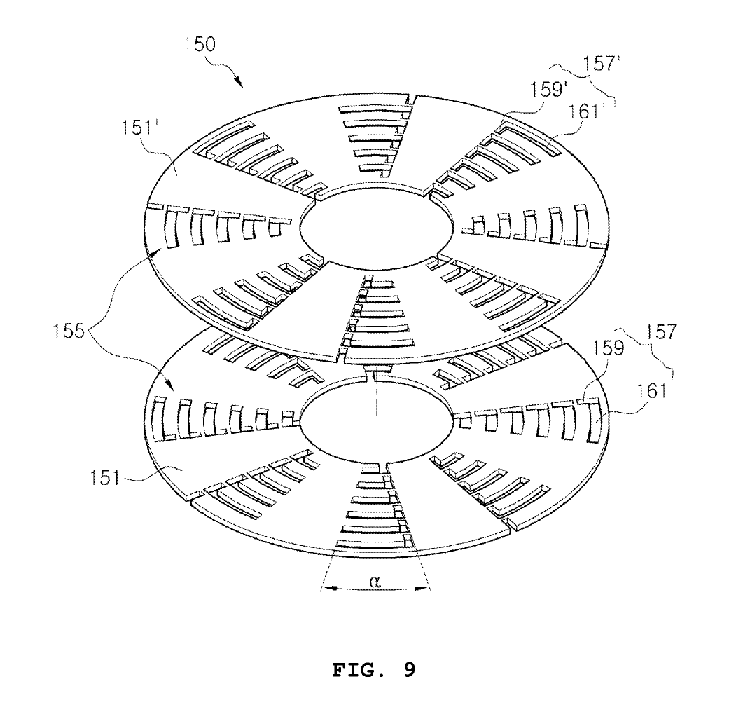

Particularly, as shown in FIG. 9, the discs 151 and 151′ have the flow passage units having the same patterns as each other, and accordingly, the disc 151′ is turned over and stacked on the disc 151, thus forming the flow passage portions 155. According to the present invention, therefore, the flow passage units having the same patterns as each other are formed on the discs to form one flow passage portion pattern, which provides the easiness in manufacturing the discs.

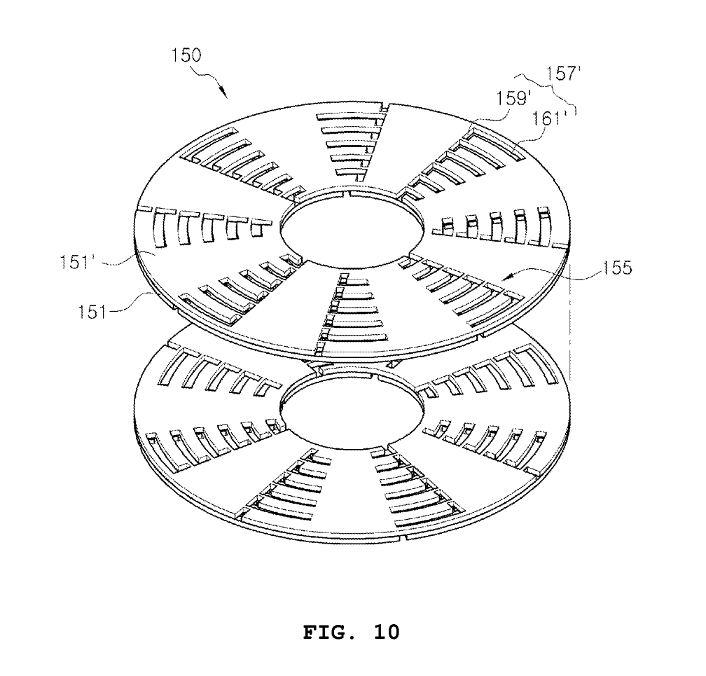

In this case, further, the flow passage units are spaced apart from each other by a given distance on the disc in a radial direction of the disc, and accordingly, as shown in FIG. 10, the discs 151 and 151′ forming the flow passage portions are rotated by the half of the angle between the flow passage portions and then stacked on the discs forming other flow passage portions, so that even if the flow passage units are penetratedly formed into the discs, the flow passage portions can be formed without having any partitions.

Further, the entry portions 159 and the passage portions 161 are connected with each other at a right or acute angle with respect to each other, but under the basic configuration as shown in FIGS. 7 to 12, they are connected with each other at a given acute angle.

That is, as shown in FIG. 11, the entry portion 159 and the passage portion 161 are connected with each other at the given acute angle less than 90°. Further, the width a of the entry portion 159 is shorter than the width b of the passage portion 161. The loss of energy occurring when the width a of the entry portion 159 is equal to the width b of the passage portion 161 is larger than that when width a of the entry portion 159 is shorter than the width b of the passage portion 161. So as to allow the passage portion 161 wherein the entering fluid forms vortexes and is changed in a vertical direction thereof to be connected with the entry portion 159 of the flow passage unit 157 on the stacked disc connected to the passage portion 161, however, it is desirable that the width a of the entry portion 159 be shorter than the width b of the passage portion 161.

In more detail, when the fluid moving along the passage portion 161 is changed in the vertical direction and enters the entry portion 159, the entering space becomes reduced to cause a resistance in the movement of the fluid.

Further, a vortex forming portion 163 is formed on the end of the passage portion 161 and forms vortexes before the fluid enters the entry portion 159 of the flow passage unit formed on another disc from the end of the passage portion 161 in the state where the entry portion 159 of the flow passage unit formed on another disc connected to the end of the passage portion 161 is spaced apart from the end and side surfaces of the passage portion 161 on the plane thereof.

In more detail, the vortex forming portion 163 is formed on the end of the passage portion 161, and as shown in FIG. 11, when the entry portions 159 of the stacked discs are connected with each other in the vertical direction thereof, the vortex forming portion 163 has spaces c and d on the plane, in which vortexes are generated in the fluid.

At this time, the spaces c and d may be extended to increase the loss of energy through the formation of relatively large vortexes, but desirably, they are formed shorter than the width a of the entry portion 159.

Further, the length e of the entry portion 159′ of the disc stacked on top of the vortex forming portion 163 on the plane is desirably longer than the width a of the entry portion 159 so as to prevent the flow passage from being blocked by means of the foreign materials introduced thereinto.

The distance f between the passage portion 161 of one disc and the passage portion 161′ of the disc stacked thereon is previously calculated and determined to a structurally stable value in accordance with the pressure and temperature under the conditions wherein the present invention is adopted.

Moreover, the flow passage length k of the entry portion 159 is desirably formed by adding the length e of the entry portion 159′ of the stacked disc and the distance f between the passage portion 161 of one disc and the passage portion 161′ of the disc stacked thereon.

Further, if the entry portion 159 and the passage portion 161 are connected with each other at a given acute angle ⊖ less than 90°, the direction changing angle from the entry portion 159 to the passage portion 161 becomes increased, thus inducing a relatively larger amount of energy loss of the fluid.

The passage portion 161 is curvedly formed in the circumferential direction of the disc. If the passage portion 161 is curvedly formed, the length of the passage portion 161 can be increased and further friction can be continuously applied to the fluid. That is, the fluid changed in direction to the acute angle is passed through the long flow passage of the passage portion 161, thus generating the loss of energy through the friction with the passage portion 161.

Furthermore, roughness or irregularity processing is performed on the inner surfaces of the entry portion 159 and the passage portion 161 of the flow passage unit 157, thus more increasing the loss of energy of the fluid.

The lengths of the passage portions 161 constituting one flow passage are formed within the range of a given angle (see ‘α’ in FIG. 9) from the center of the disc. Accordingly, the lengths of the passage portions 161 become longer as the passage portions 161 become distant from the center of the disc, so that when the lengths of the passage portions 161 are increased, the loss of energy of the fluid can be increased.

The flow of fluid through the flow passage units 157 and the vortex forming portions 163 constituting the flow passage portion 155 is generated as shown in FIG. 12. That is, the fluid entering the entry portion 159 of the disc 151 enters the passage portion 161 larger in width than the entry portion 158 and is thus expanded. After that, the fluid moves along the curved surface of the passage portion 161 to produce the loss of energy through the application of friction with the curved surface thereto. The fluid reaches the end of the passage portion 161, and before the fluid enters the entry portion 159′ of the flow passage unit 157′ of the stacked disc 151′, the vortexes are formed in the vortex forming portion 163 formed on the end of the passage portion 161 to form vortex flow patterns. The width of the entry portion 159′ is shorter than that of the passage portion 161 and changed in direction in the vertical direction, so that the fluid entering the entry portion 159′ is contracted to cause the loss of energy. The above-mentioned processes are repeatedly carried out from the inlet of the flow passage to the outlet thereof, thus reducing the pressure of the fluid and the flowing velocity thereof.

Further, high velocity and pressure fluid initially entering the flow passage is uniformly decreased through the above-mentioned processes, thus suppressing the problems causing the damages of the valve, such as cavitation, hammering and the like, which occur due to a high flow rate in the state where the valve is open.

Further, the flow passages can be formed compactedly in the available volume of the cage.

Modified Configuration

Next, an explanation on the modified configuration of the device according to the present invention will be given.

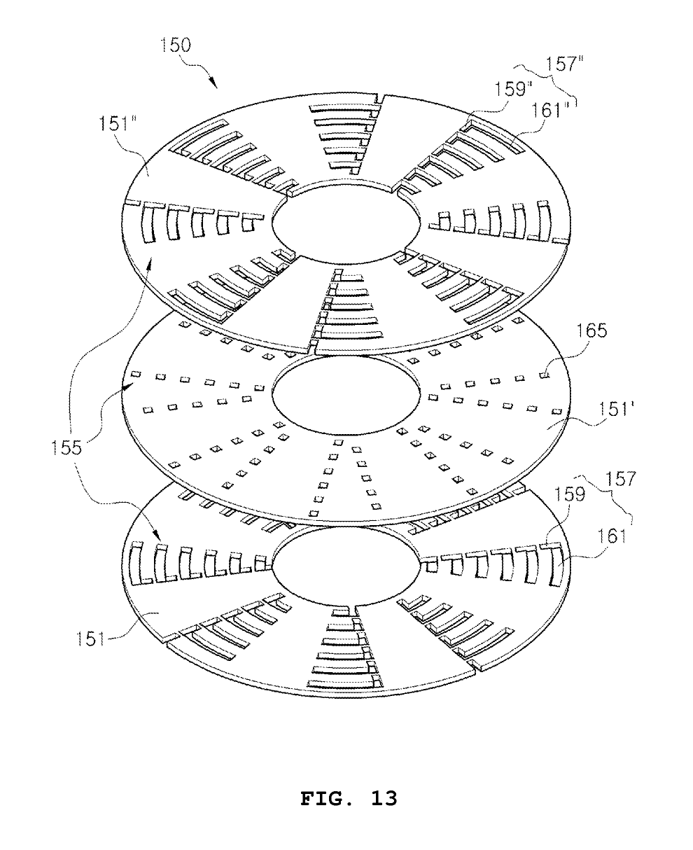

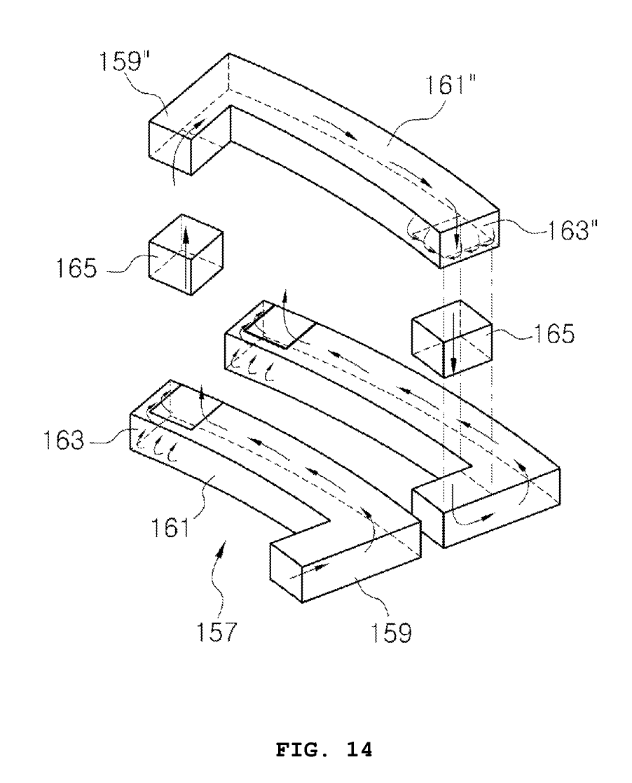

FIGS. 13 and 14 show the arrangements of flow passage units and connection units under the modified configuration of the device for reducing the pressure and velocity of a flowing fluid according to the present invention.

As shown, under the basic configuration of the device according to the present invention, the flow passage portions 155 are formed by means of the cooperative cooperation between the two discs 151 and 151′, but under the modified configuration thereof, the flow passage portions 155 are formed by means of the cooperative cooperation between three or more discs 151, 151′ and 151″. In addition to the flow passage units 157 and 157″ mentioned in the basic configuration, that is, the flow passage portions 155 further include connection units 165 connecting the flow passage units 157 and 157″ with each other in the vertical direction.

Each connection unit 165 serves as a passage connecting the passage portion 161 formed on the disc 151 stacked on one end thereof and the entry portion 159″ formed on the disc 151″ stacked on the other end thereof with each other, and the length of the passage is increased in accordance with the number of stacked discs 151′ on which the connection units 165 are formed.

The modified configuration of the device according to the present invention is the same as the basic configuration thereof except that the discs 151′ on which the connection units 165 are formed are stacked between the discs 151 and 151″, and for the brief description, therefore, the more detailed description on other parts in the modified configuration of the device according to the present invention will be avoided.

Flow Passage Portion Patterns

Next, an explanation on the patterns of the flow passage portions will be given. The patterns of the flow passage portions as will be described below are explained under the basis configuration of the device according to the present invention, but they may be formed under the modified configuration or the combination of the basic configuration and the modified configuration of the device according to the present invention.

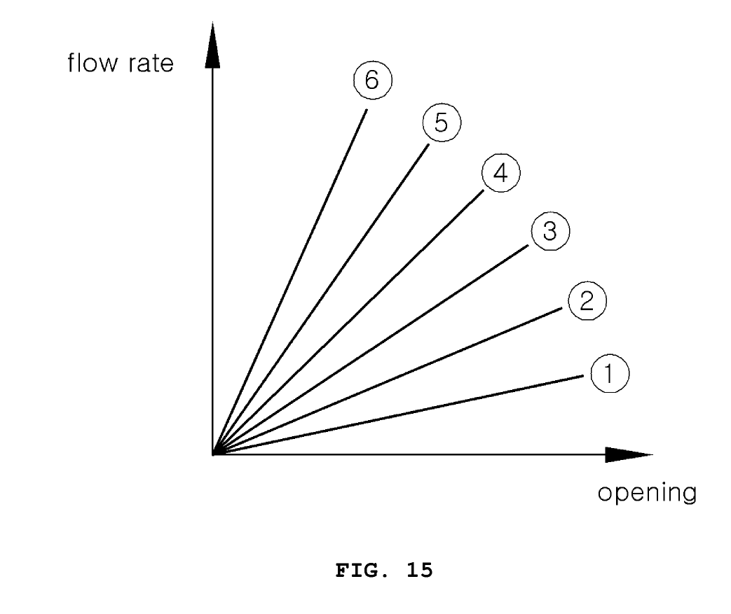

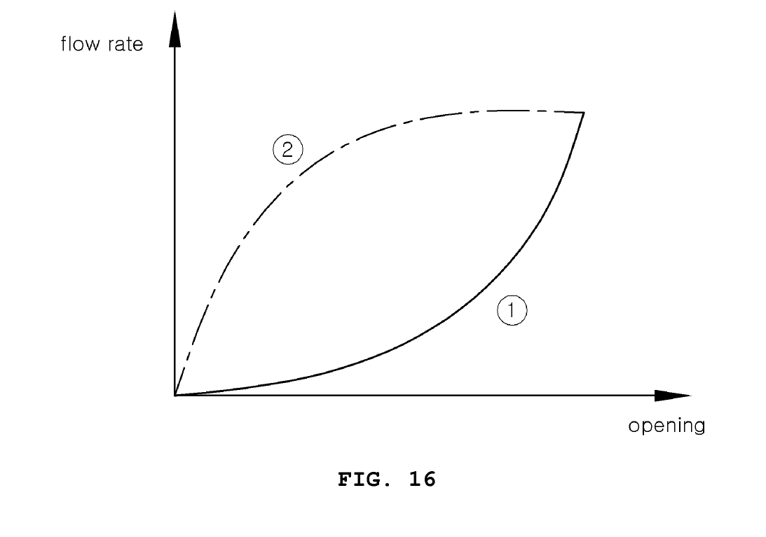

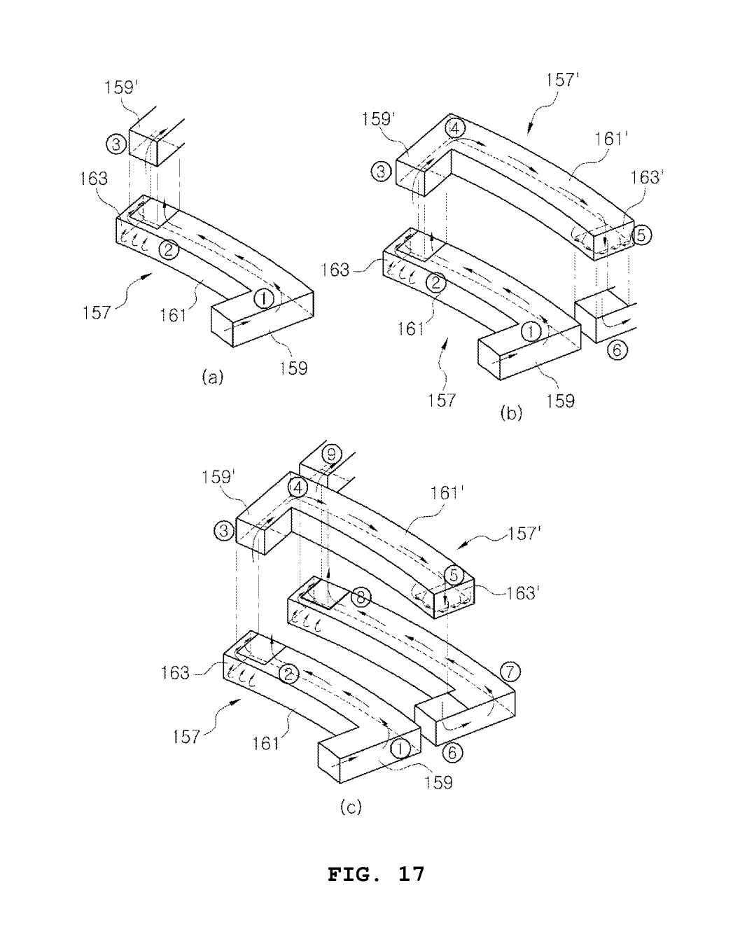

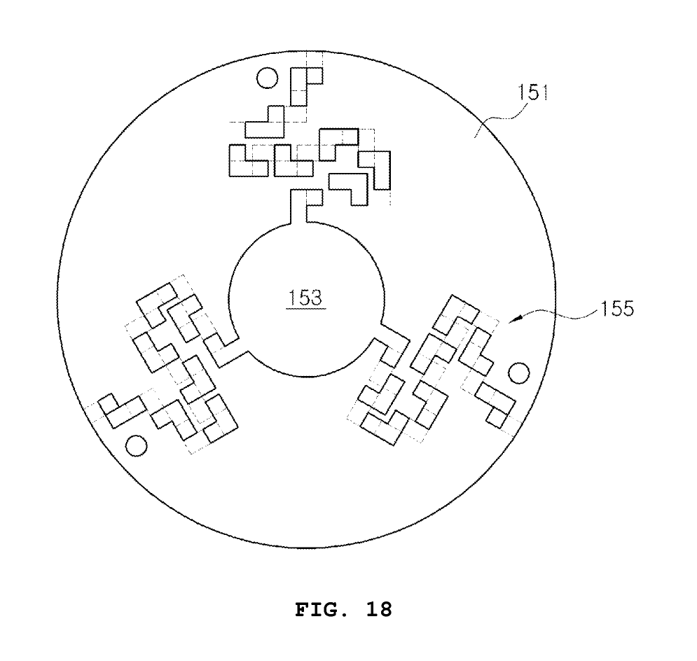

FIGS. 15 and 16 are graphs showing flow rate variations according to a degree of opening, FIGS. 17a to 17c show the unit pattern of the flow passage portion, and FIGS. 18 to 23 show various patterns of the flow passage portions according to the present invention.

For the convenience of the drawings, the vortex forming portions 163 in the patterns of the flow passage portions are not illustrated in FIGS. 18 to 23, and the linear flow passage unit 157 under the basic configuration may be changed into the curved flow passage unit 157. Further, the solid lines indicate the flow passage units 157 formed on the disc located on top of the discs stacked on each other, and the dotted lines indicate the flow passage units 157 formed on the disc stacked underneath the disc.

As shown in FIG. 13, the flow rate of the fluid passing through the cage is increased in accordance with the degree of opening of the cage occurring through the upward movement of the plug. If the flow passage portions formed on the cage have the same patterns as each other, at this time, the increment of the flow rate of the fluid according to the opening of the cage is obtained in the form of the linear line.

By the way, the inclination of the linear line indicating the increment of the flow rate of the fluid according to the opening of the cage should be increased or decreased in accordance with the installation conditions or functions of the valve. Further, the increment of the flow rate of the fluid according to the opening of the cage may be obtained not in the form of the linear line, but in the form of a curved line. For example, the flow rate of the fluid becomes slowly increased at the initial opening of the cage, but it is drastically increased in the state where the cage becomes gradually open. Otherwise, the flow rate of the fluid becomes drastically increased at the initial opening of the cage, but it is slowly increased in the state where the cage becomes gradually open. In these cases, the flow rate of the fluid may be more slowly or more drastically increased.

If the correlation between the opening of the cage and the flow rate of the fluid is changeable in accordance with the installation conditions or functions of the valve, the conveniences in the adoption and application of the valve can be of course increased.

However, since the flow passages having the same shapes as each other are repeatedly formed in the conventional valve, only the correlation between the opening of the cage and the flow rate of the fluid is provided in the form of the linear line having a given inclination.

According to the present invention, therefore, one or more flow passage portion patterns are formed on the disc on the basis of the number of direction changing times of the flow passages and the number of flow passage portions, thus controlling the increasing velocity of the flow rate of the fluid according to the degree of opening formed by the upward movements of the plug.

The flow passage portion pattern suggested in the present invention is obtained by repeatedly forming one or more unit patterns as shown in FIG. 17a.

That is, three direction changing times occur in the unit pattern as shown in FIG. 17a. In the unit pattern as shown in FIG. 17a, in more detail, the direction change in the circumferential direction from the entry portion 159 toward the passage portion 161 occurs (see \textcircled{1} in FIG. 17a), the direction change in the vertical direction toward the entry portion 159′ of the stacked disc from the passage portion 161 occurs (see \textcircled{2} in FIG. 17a), and the direction change in the vertical direction so as to enter the entry portion 159′ of the stacked disc occurs (see \textcircled{3} in FIG. 17a).

Such unit patterns are continuously connected as shown in FIGS. 17b and 17c. That is, if two unit patterns are connected to each other as shown in FIG. 17b, total six direction changing times occur (see \textcircled{1}˜\textcircled{6} in FIG. 17b), and if three unit patterns are connected to each other as shown in FIG. 17c, total nine direction changing times occur (see \textcircled{1}˜\textcircled{9} in FIG. 17c).

The flow passage portion pattern according to the present invention is formed with such unit patterns, and the number of unit patterns can be increased so as to optimize the loss of energy of the fluid. At this time, the number of direction changing times corresponds to the multiples of 3.

The flow passage portion patterns having the plurality of unit patterns are shown in FIGS. 18 to 23. However, the flow passage portion patterns are variously formed in accordance with the number of unit patterns, the arrangement of the unit patterns, and the increment and decrement of the number of direction changing times through the combination of the basic configuration and the modified configuration of the present invention.

Further, the flow passage portion patterns suggested in the present invention are formed to provide 3 to 17 flow passage portions 155, but the number of flow passage portions 155 may be further increased or decreased.

Each flow passage portion 155 will be in detail explained hereinafter.

First, the flow passage portion pattern as shown in FIG. 18 is formed to provide three flow passage portions 155 and 45 direction changing times. In case of the flow passage portion pattern as shown in FIG. 18, accordingly, the number of flow passage portions is relatively small, and the fluid is changed in direction 45 times in the circumferential and vertical direction of the cage so as to be passed through the cage, so that the amount of fluid passed through the cage is relatively small.

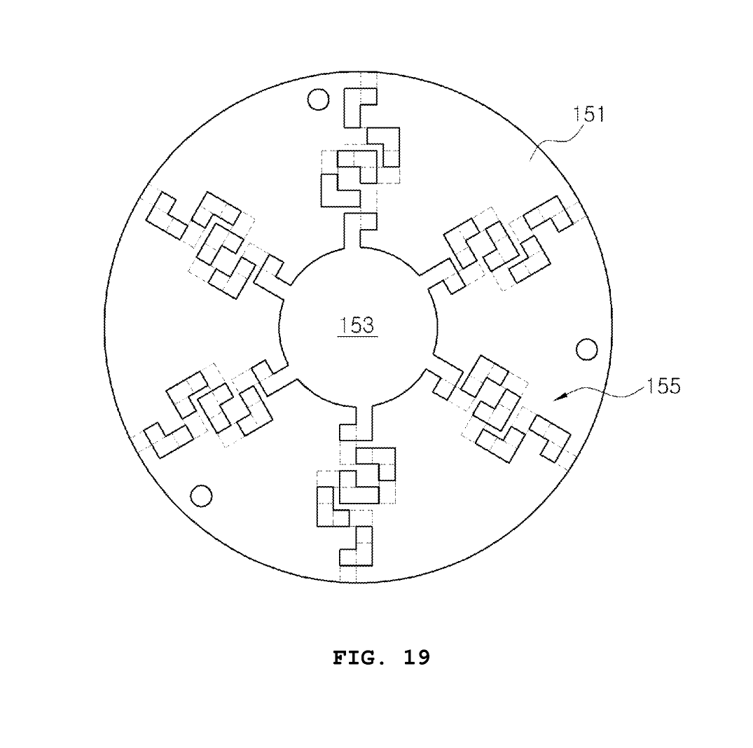

The flow passage portion pattern as shown in FIG. 19 is formed to provide six flow passage portions 155 and 27 direction changing times. In case of the flow passage portion pattern as shown in FIG. 19, accordingly, the number of flow passage portions is relatively larger than that as shown in FIG. 18 and the number of direction changing times is smaller than that as shown in FIG. 18, so that the amount of fluid passed through the cage is relatively larger than that as shown in FIG. 18 per unit time.

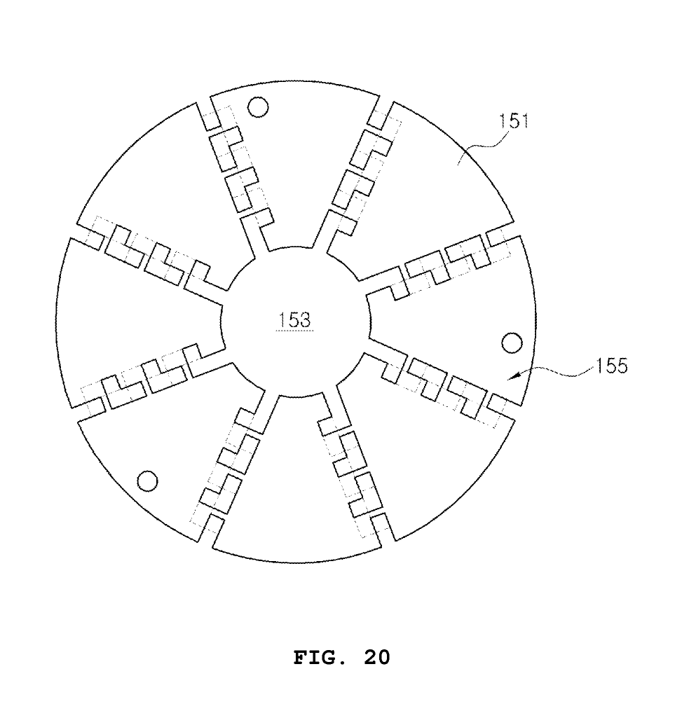

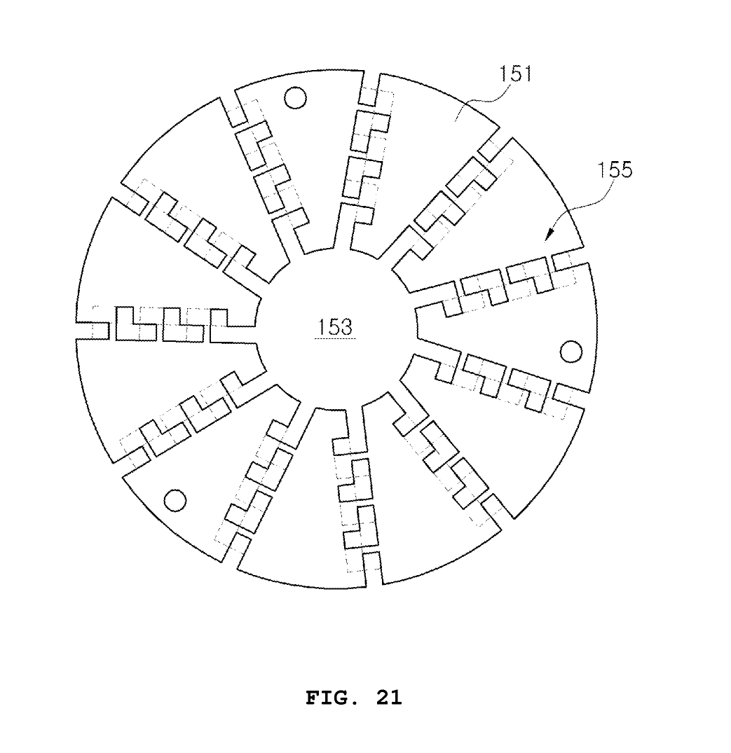

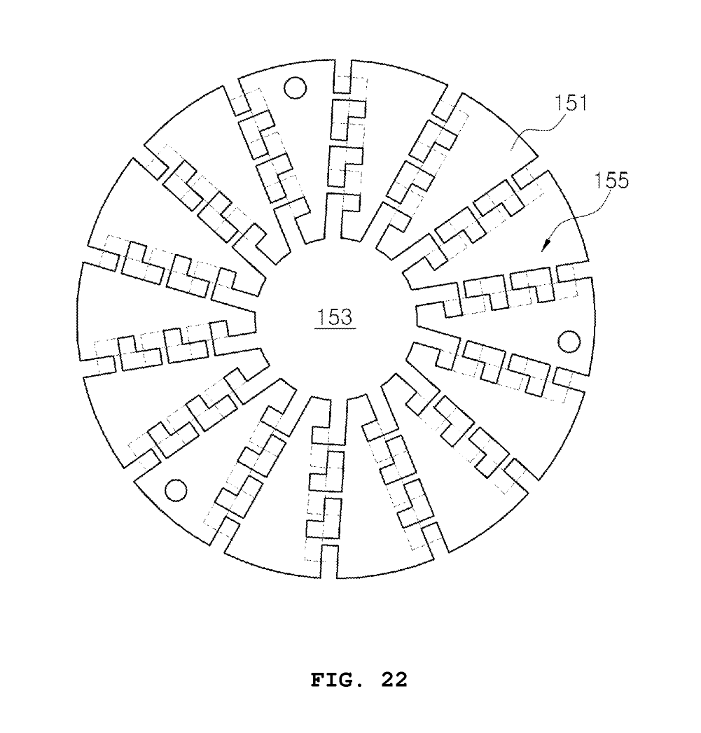

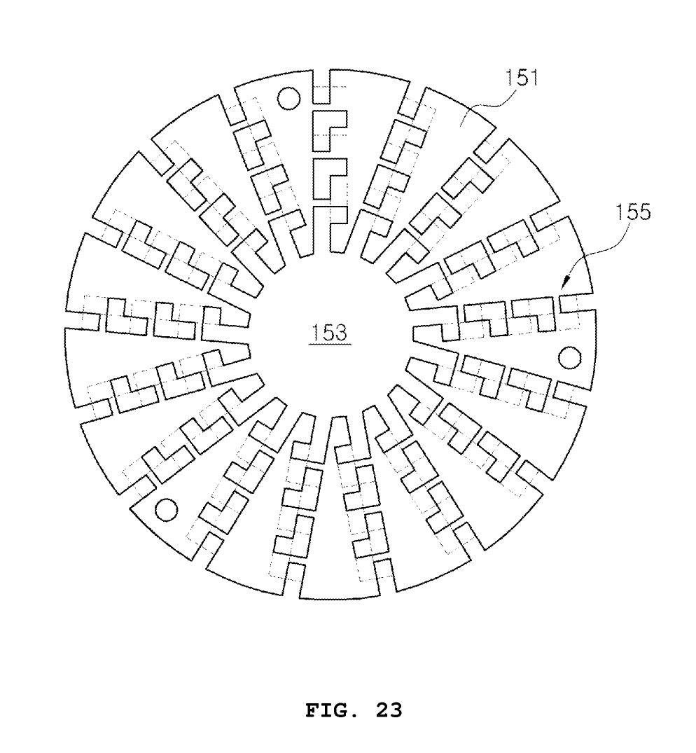

The flow passage portion patterns as shown in FIGS. 20 to 23 are formed to provide the same number of direction changing times as each other, but they have different number of flow passage portions 155 from each other. That is, the flow passage portion pattern as shown in FIG. 20 is formed to provide seven flow passage portions 155, the flow passage portion pattern as shown in FIG. 21 to provide 11 flow passage portions 155, the flow passage portion pattern as shown in FIG. 22 to provide 14 flow passage portions 155, and the flow passage portion pattern as shown in FIG. 23 to provide 17 flow passage portions 155. The number of flow passage portions is increased as it goes from the flow passage portion pattern as shown in FIG. 20 toward the flow passage portion pattern as shown in FIG. 23, so that the amount of fluid passed through the cage is gradually increased per unit time.

If any one of the six flow passage portion patterns constitutes the cage, the increment of the flow rate of the fluid according to the opening of the cage is formed in the linear line. However, since the amount of fluid passed through the cage per unit time is increased as it goes from the flow passage portion pattern as shown in FIG. 18 toward the flow passage portion pattern as shown in FIG. 23, the inclination of the linear line becomes gradually increased as it goes from \textcircled{1} toward \textcircled{6} of FIG. 15. Accordingly, if it is desired to slowly increase the flow rate of the fluid according to the opening of the cage, the flow passage portion pattern as shown in FIG. 18 is adopted, and if it is desired to drastically increase the flow rate of the fluid according to the opening of the cage, the flow passage portion pattern as shown in FIG. 23 is adopted.

Further, the six flow passage portion patterns are combinedly used to obtain the increment of the flow rate of the fluid in the form of the curved line. For example, if it is desired to slowly increase the flow rate of the fluid according to the opening of the cage, the flow passage portion pattern as shown in FIG. 18 is disposed on the bottom end of the cage, and the flow passage portion patterns as shown in FIGS. 19 to 23 are stacked sequentially on top of the flow passage portion pattern as shown in FIG. 18, so that the flow rate of the fluid is slowly increased at the initial opening and drastically increased as the degree of opening is large, as shown in \textcircled{1} of FIG. 16.

Contrarily, the flow passage portion pattern as shown in FIG. 23 is disposed on the bottom end of the cage, and the flow passage portion patterns as shown in FIGS. 22 to 18 are stacked sequentially on top of the flow passage portion pattern as shown in FIG. 23, so that the flow rate of the fluid is drastically increased at the initial opening and gradually increased as the degree of opening is large, as shown in \textcircled{2} of FIG. 16.

Accordingly, the cage can be manufactured by the combination of the six flow passage portion patterns in accordance with the installation conditions and functions of the valve.

While the present invention will be described with reference to the particular illustrative embodiments, it is not to be restricted by the embodiment but only by the appended claims. It is to be appreciated that those skilled in the art can change or modify the embodiments without departing from the scope and spirit of the present invention.

What is claimed is:

1. A device for reducing the pressure and velocity of a flowing fluid, which is disposed in a fluid processing device having a body having an inlet and an outlet, a plug moved between the inlet and the outlet so as to adjust the flow rate of the fluid, a seat ring adapted to block the flow of the fluid in such a manner as to be brought into contact with the plug, and a cage contacted with the outer peripheral surface of the plug so as to allow the fluid to be passed therethrough in accordance with the upward and downward movements of the plug, wherein the cage has a plurality of discs each having a through hole with which the outer peripheral surface of the plug is brought into close contact, and the discs are stacked on top of each other in the center shaft direction of the cage, the stacked discs being adapted to form flow passage portions so as to form flow passages therebetween, the flow passage portions communicating with the outer peripheral surfaces of the discs and the inner peripheral surfaces of the discs corresponding to the through holes of the discs and being changed in direction in circumferential directions and vertical directions of the stacked discs, the discs being stacked by applying one or more flow passage portion patterns based on the number of direction changing times of the flow passages and the number of flow passage portions to the discs so as to control the increasing velocity of the flow rate of the fluid according to the degree of opening upon upward movements of the plug, each flow passage portion comprising a plurality of flow passage units each having an entry portion and a passage portion connectedly extended from the entry portion at a right or acute angle with respect to the entry portion, and the passage portion of one flow passage unit being connected to the entry portion of the flow passage unit of another disc stacked on the disc through the connection units stacked on top thereof, the width of the passage portion being larger than the width of the entry portion, and the passage portion having a vortex forming portion formed on the end thereof so as to form vortexes before the fluid enters the entry portion of the flow passage unit formed on another disc from the end of the passage portion in the state where the entry portion of the flow passage unit formed on another disc connected to the end of the passage portion is spaced apart from the end and side surfaces of the passage portion on the plane thereof.

2. The device according to claim 1, wherein each flow passage portion further comprises connection units adapted to connect the flow passage units with each other in a vertical direction, and the passage portion of one flow passage unit is connected to the entry portion of the flow passage unit of another disc stacked on the disc through the connection units stacked on top thereof.

3. The device according to claim 1, wherein the flow passage portion patterns are formed on two or more discs in the same shape as each other.

4. The device according to claim 1, wherein one flow passage portion pattern has the number of direction changing times corresponding to the multiples of 3.

5. The device according to claim 1, wherein the entry portion and the passage portion are provided in the form of grooves depressed to a given depth.

6. The device according to claim 1, wherein the entry portion and the passage portion are penetratedly formed into each disc.

7. The device according to claim 6, wherein partitions are stacked on the top and underside of the discs forming one flow passage portion pattern.

8. The device according to claim 1, wherein the passage portion is curvedly formed.
